(19) United States
(12) Patent Application Publication
(10) Pub. No.: US 2014/0137217 A1
(43) Pub. Date: May 15, 2014

(54) VERIFYING AN INDIVIDUAL USING INFORMATION FROM A SOCIAL NETWORK

(71) Applicants: Eric Kowalchyk, Mountain View, CA (US); Mui Anne Chang, Mountain View, CA (US); Vikram Rangnekar, Mountain View, CA (US)

(72) Inventors: Eric Kowalchyk, Mountain View, CA (US); Mui Anne Chang, Mountain View, CA (US); Vikram Rangnekar, Mountain View, CA (US)

(21) Appl. No.: 13/676,317

(22) Filed: Nov. 14, 2012

(51) Int. Cl. G06F 21/20

(52) U.S. Cl. 726/5

(57) ABSTRACT

Systems and methods for verifying individuals using social network information are described. In some examples, the systems and methods receive a request to verify an individual, obtain social network information associated with the individual, and provide the social network information to the requestor.

### TECHNICAL FIELD

The present disclosure generally relates to verification and/or validation services. More specifically, the present disclosure relates to methods, systems and computer program products for verifying an individual using information from a social network.

### BACKGROUND

An online service provider, such as a retail site or banking site, encounters a variety of different users everyday. Most of the users are trustworthy and reliable, and provide accurate and truthful information about whom they are, when requested by the site. However, some users will attempt to obfuscate their identity, for a variety of reasons. For example, a person may attempt to access a site using another person's identity or providing misleading or purposefully incorrect information.

### DESCRIPTION OF THE DRAWINGS

Some embodiments of the technology are illustrated by way of example and not limitation in the figures of the accompanying drawings, in which:

FIG. 1 is a block diagram illustrating an example of a network environment including a server operating a system for verifying an individual using information from a social network, consistent with some embodiments.

FIG. 2 is a block diagram illustrating modules of a verification system, consistent with some embodiments.

FIG. 3 is a flow diagram illustrating an example method performed by a verification system associated with a social network for providing social network information to a requesting system, consistent with some embodiments.

FIG. 4 is a flow diagram illustrating an example method performed by a requesting system for determining whether to authorize access to an individual based on information received from a social network, consistent with some embodiments.

FIG. 5 is a block diagram of a machine in the form of a computing device within which a set of instructions, for causing the machine to perform any one or more of the methodologies discussed herein, may be executed.

### DETAILED DESCRIPTION

### Overview

The present disclosure describes methods, systems, and computer program products, which individually provide functionality for verifying an individual using information from a social network. In some examples, the systems and methods enable a requesting system, such as an online web service (e.g., a bank, a retail store, and so on), to validate, verify, and/or authorize an individual requesting access to the service based on information associated with the individual and obtained from a social network (e.g., an online professional network) that includes the individual as a member.

In some examples, a social network may include, or engage, a verification system that is configured to receive a request from a requesting system to verify an individual, obtain information from a social network that includes the individual as a member, and provide information associated with verifying the individual at the requesting system.

As an example, an individual wishes to purchase car insurance via an online insurance company. During the enrolment process, the company website sends a request to the individual's online professional network to provide information about the individual, such as information that verifies the individual. The professional network receives the request, and provides information (e.g., work history, connection information, verification scores, and so on) that verifies the individual to the company website. Using the information, the insurance company authorizes the individual to purchase insurance.

Thus, in some examples, a verification system may leverage information stored by a social network service, such as an online professional network, when providing information associated with an individual that may assist in verifying, validating, and/or authorizing the individual at a requesting system, such as an site providing online services, among other things. The verifying system may, therefore, provide insight to requesting system about the individual, enabling the requesting system to determine whether the individual is an actual person, among other benefits.

In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

Other advantages and aspects of the inventive subject matter will be readily apparent from the description of the figures that follows.

### Suitable System

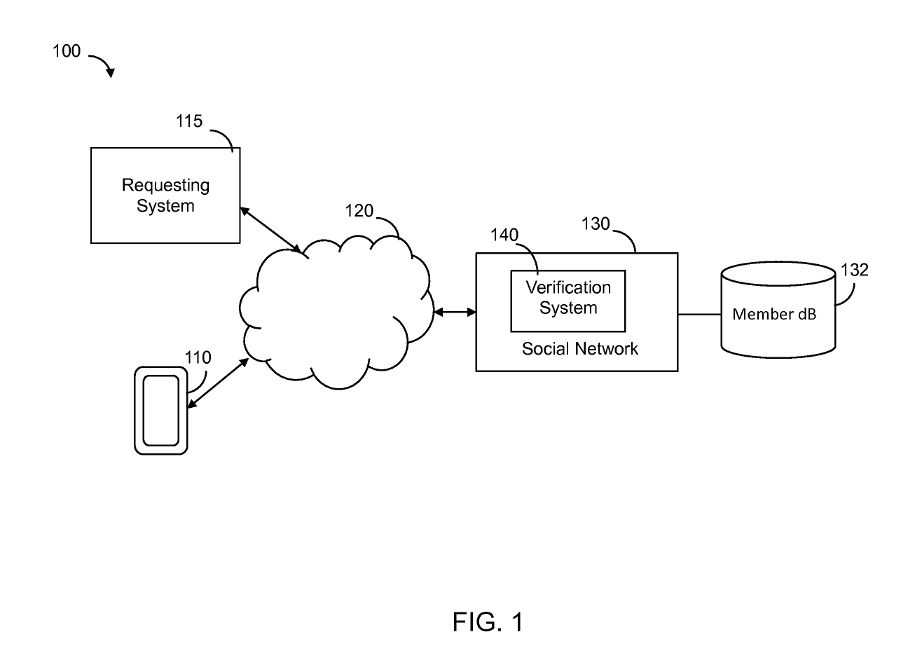

FIG. 1 is a block diagram illustrating an example of a network environment 100 including a server operating a system for verifying an individual using information from a social network, consistent with some embodiments. The network environment 100 includes a user device 110, such as a mobile device or computing device, and a requesting system 115, which accesses a social network service 130 over a network 120. The social network service 130 may be a professional social network or any social network that includes members, where a member is connected to, friends with, or otherwise affiliated with some of the other members of the network. The social network service 130 may include a verification system 140 that includes systems and performs methods for providing information associated with members to requesting systems, such as requesting system 115.

The social network service 130 may contain, store, or have access to various types of information, such as information 132 associated with the members of the network, information associated with companies that have a presence within the social network (e.g., post listings for available jobs), information associated with devices (i.e., information associated with user device 110) that communicate with the social network, and so on.

In various example embodiments, one or more portions of the network 120 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, any other type of network, or a combination of two or more such networks. The user device 110 may be any suitable computing device, such as a smart phone, a tablet, a laptop, gaming device, and/or any mobile device or computing device configured to display job listings and receive selections from users of objects displayed by webpages, emails, and/or apps.

A social network, such as the social network service 130, is a useful place in which to obtain various types of information associated with members that are actively or passively looking for a job. Often, a social network or other similar site, such as LinkedIn, Facebook, Google+, Twitter, and so on, stores various types of information or attributes associated with members of the site. For example, a friend-based social networking site may store interest information for a member (e.g., information about things a member “likes”), whereas a business-based or professional social networking site may store accomplishment or experience information for a member (e.g., educational or work experience information). Additionally, the social network 130 may store a variety of information associated with a member's social graph, such as information identifying other members within the member's social graph.

For example, an individual associated with the user device 110 attempts to access a service provided by the requesting system 115. In order to verify the individual, the verification system 140 may receive a request from the requesting system 115 to verify the individual attempting to access the service at the requesting system 115. The requesting system 115 may be an online web service or other online website that provides services or other functions, such as an online bank, an online retail store, an online content provider, an online membership site, and so on. The verification system 140 may obtain information about the individual from the social network database 132, and provide the information to the requesting system 115. The requesting system 115 may then use the provided information to verify the individual, and authorize the individual to access and use the provided service.

### Verifying Individuals Using Social Network Information

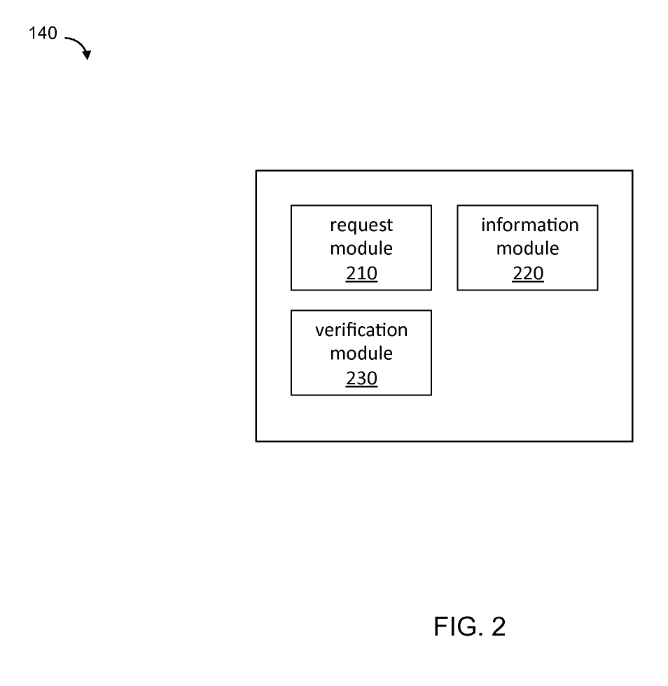

As described herein, in some example embodiments, the verification system 140 utilizes various types of data or other information stored by a social network in order to provide verification information to a requesting system. FIG. 2 is a block diagram illustrating modules of a verification system, consistent with some embodiments.

As illustrated in FIG. 2, the verification system 140 includes a variety of functional modules, such as a request module 210, an information module 220, and a verification module 230. One skilled in the art will appreciate that the functional modules are implemented with a combination of software (e.g., executable instructions, or computer code) and hardware (e.g., at least a memory and processor). Accordingly, as used herein, in some embodiments a module is a processor-implemented module and represents a computing device having a processor that is at least temporarily configured and/or programmed by executable instructions stored in memory to perform one or more of the particular functions that are described herein.

In some examples, the request module 210 is configured and/or programmed to receive and process a request from a requesting system, such as a request to provide information about an individual. For example, the request module 210 may receive a request to provide information about an individual attempting to access a service provided by the requesting system.

The request module 210 may parse or otherwise identify within a received request certain information about the individual to be provided to the requesting system. The request module 210 may identify a type of information associated with the individual to be provided to the requesting system, a type of verification score or metric associated with the individual to be provided to the requesting system, and so on.

For example, a requesting system associated with an online matchmaker site may request certain information in order to verify an individual as an actual person, while a requesting system associated with a mortgage broker may request certain other information that provides insight into the type of individual requesting access.

In some examples, the information module 220 is configured and/or programmed to identify and/or obtain information associated with the individual from a social network, such as information associated with the individual from a social network that includes the individual as a member. For example, the information module 220 may identify and/or obtain information from member database 132 associated with social network 130.

Example data and/or information that may be obtained by the information module 220 includes:

Profile information, such as information associated with a member's educational background (e.g., school information, degree information, grade information, exam information, activity information, organization information, and so on), work or professional history (e.g., company information, job title information, job skills information, job responsibility information, length of employment information, and so on), member information (e.g., residence information, citizenship information, language information, activity and interest information, and so on), and so on;

Social graph information, such as profile information associated with friends, connections, group affiliations, references, and so on, of a member; and so on;

User device information, such as information (e.g. cookies, device IDs) stored by the social network that associates a user device 110 with a member of the social network; and/or

Public information, such as information obtainable by the social network that is located at other, accessible, locations (e.g., other social network services, microblogs, and so on) via the network 120.

In some examples, the verification module 230 is configured and/or programmed to provide some or all of the obtained information to a requesting system. For example, the verification module 230 may provide information obtained via the information module 220 to the requesting system 115. The verification module 230 may provide the information in a number of ways, such as directly communicating the information to the requesting system 115, transmitting a message to the user device 110 associated with the individual, performing an action via an application associated with the social network that is supported by the user device 110, and so on.

The verification module 230, in some examples, may calculate or determine a verification metric or score based on the obtained information associated with the individual. For example, the verification module 230 may determine an individual is verified based the type of information obtained about the individual, and provide an indication that represents such a determination. As another example, the verification module 230 may calculate a score or metric (e.g., a score between 1-100) that indicates a comparative or granular determination associated with verifying the individual. The following scenarios provide example determinations performed by the verification module 230:

The obtained information indicates the individual has a college degree and is currently employed, and the verification module 230 determines the individual to be verified;

The obtained information indicates the individual has a minimal amount of connections within the social network; and determines the individual to not be verified;

The obtained information indicates the individual has a lengthy work history with a single employer, with many connections also associated with the employer, and assigns a high verification score (e.g., 90 out of 100) to the individual; and so on.

Of course, one or ordinary skill in the art will appreciate that the verification module 230 may utilize a variety of techniques, scenarios, and/or rules-based processes when performing a verification determination or calculation based on social network information associated with an individual.

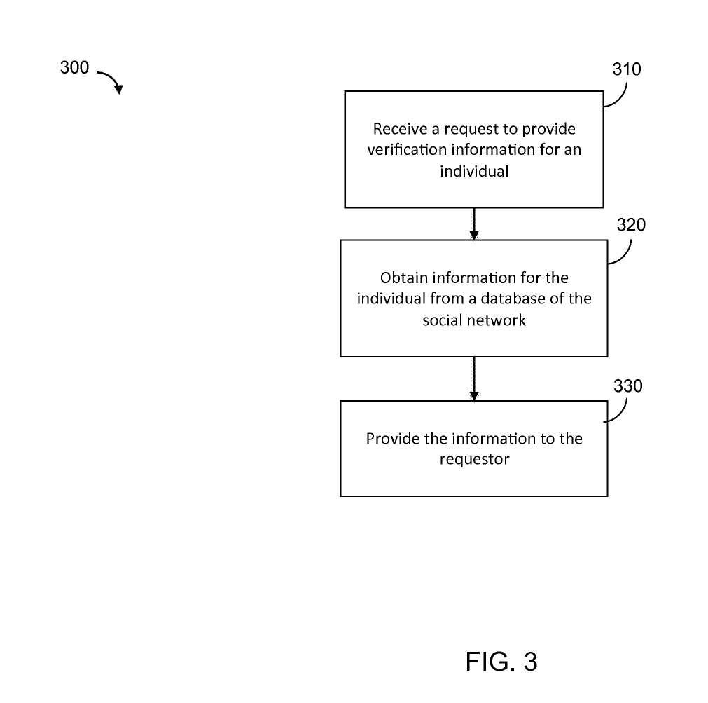

As described herein, the verification system 140 may perform a variety of processes or methods in order to provide information to a requesting system that supports or otherwise accompanies an individual attempting to access services provided by the requesting system, among other things. FIG. 3 is a flow diagram illustrating an example method 300 performed by a verification system associated with a social network for providing social network information to a requesting system, consistent with some embodiments.

In step 310, the verification system receives a request to provide information about an individual. For example, the request module 210 of the verification system 140 receives a request to provide information about an individual, such as an individual seeking access to services provided by the requesting system.

In some examples, the request module 210 may parse the request to identify a type of information to provide to the requesting system, to identify a mechanism in which to communicate the information to the requesting system, to identify whether to provide a verification score or metric for the individual, and so on.

In step 320, the verification system obtains information associated with the individual from a social network that includes the individual as a member. For example, the information module 220 of the verification system 140 may identify and/or obtain information from the member database 132 of the social network 130.

As described herein, the information module 220 may obtain various types of information associated with an individual, such as profile information, social graph information, and so on. The information module 220 may obtain information specifically requested by the requesting system 115. For example, the request module 210 may parse a received request, determine the request includes a request for information about the individual's professional history, and the information module 220 may obtain information from the member database 132 that is associated with the individual's skills and previous employers, among other things.

In step 330, the verification system provides information to the requesting system. For example, the verification module 230 of the verification system 140 transmits the requested information to the requesting system 115. As described herein, the verification module 230 may transmit the information directly (e.g., via various APIs, direct messaging protocols, and so on) to the requesting system 115, may transmit the information (e.g., via email, instant messaging, text messaging, and so on) to a user device 110 associated with the individual, may perform an action at an application running on the user device 110, and so on.

In some examples, the verification module 230 may calculate or otherwise determine a verification metric or score for the individual based on the information associated with the individual, and transmit the determined score to the requesting system. The determined score may indicate an individual is verified, or may indicate a verification level for the individual, among other things.

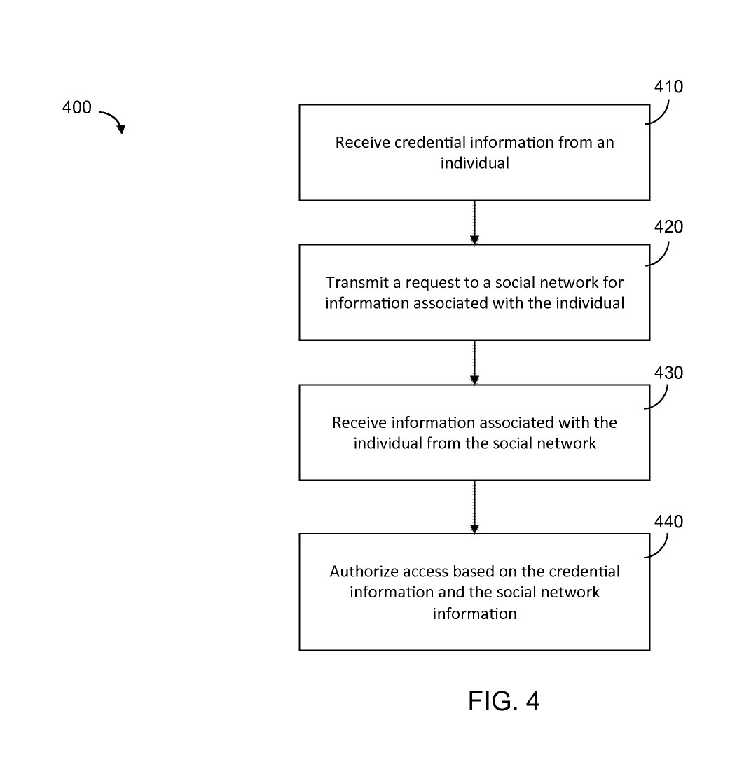

As described herein, in some examples, the requesting system 115 may utilize information provided by the verification system 140 when determining whether to authorize an individual to access a service provided by a website, among other things. FIG. 4 is a flow diagram illustrating an example method 400 performed by a requesting system for determining whether to authorize access to an individual based on information received from a social network, consistent with some embodiments.

In step 410, the requesting system 115 may receive credential information from an individual. For example, a website may receive a username and password (e.g., a username and password associated with a social network) from an individual attempting to access or use a service provided by the website.

In step 420, the requesting system 115 transmits a request to a social network that includes the individual as a member for information about the individual. The transmitted request may include, among other things, certain information associated with the individual to be provided to the requesting system.

In step 430, the requesting system 115 receives the requested information from the social network. For example, a verification system 140 associated with social network 130 may provide information associated with an individual to the requesting system.

In some examples, the requesting system 115 may generate and/or create a challenge question, or other security-based query, based on the received information, and present the question to the individual. For example, using information received from the social network, the requesting system 115 may present challenge questions that request the individual to identify connections with the social network, profile information not publically accessible (or derivable) and stored by the social network, and so on. Some example questions may include:

“Which of these people are connected to you?” or

“In what year did you graduate from University?” or

“Please match your connections to their pictures,” and so on.

In step 440, the requesting system 115 authorizes the individual to access services based on the received social network information. For example, the requesting system 115 may receive information indicating the individual is a verified individual, and authorize the individual to access services provided by the requesting system 115 based on such information.

Thus, in some examples, a requesting system 115, such as a website provided services to individuals, may utilize social network information associated with individuals to verify and/or authorize the individuals before giving access to the provided services, among other things.

The following examples illustrate scenarios in which the verification system described herein may be utilized:

Scenario 1—

A new user is creating a profile on a matchmaker site. The matchmaker site, in order to verify the new user is an actual person, sends a request for information to a social network that includes the user as a member. The social network, via a verification system, obtains information that indicates the user has over 400 connections, and provides an indication to the matchmaker site that the user is verified as an actual person, based at least on the number of connections within the network.

Scenario 2—

Before authorizing a user to start an online credit card application, a bank site sends a request to the user's social network to provide information about the user that verifies the user. The social network provides information indicating the user is currently employed and has a stable work history, and the bank site enables the user to begin the application process.

### CONCLUSION

The various operations of example methods described herein may be performed, at least partially, by one or more processors that are temporarily configured (e.g., by software) or permanently configured to perform the relevant operations. Whether temporarily or permanently configured, such processors may constitute processor-implemented modules, engines, objects or devices that operate to perform one or more operations or functions. The modules, engines, objects and devices referred to herein may, in some example embodiments, comprise processor-implemented modules, engines, objects and/or devices.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

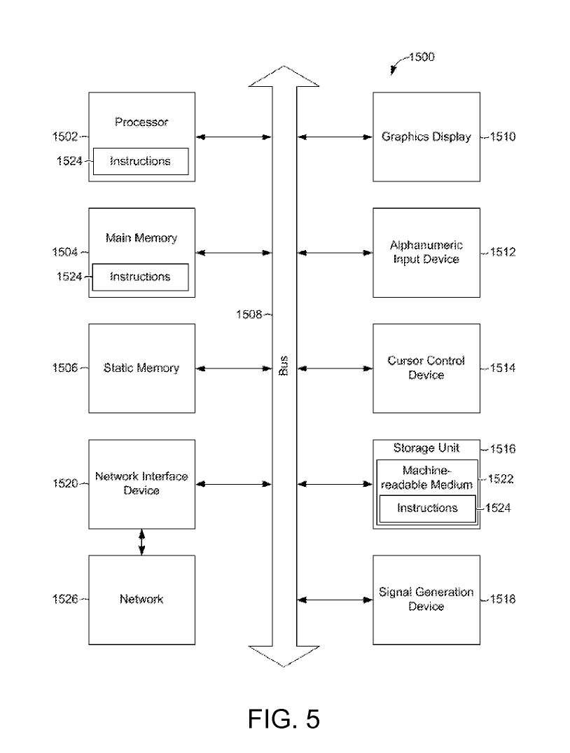

FIG. 5 is a block diagram of a machine in the form of a computer system or computing device within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. In some embodiments, the machine will be a desktop computer, or server computer, however, in alternative embodiments, the machine may be a tablet computer, a mobile phone, a personal digital assistant, a personal audio or video player, a global positioning device, a set-top box, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method, comprising:
receiving a request from a requesting system to provide information associated with an individual seeking access to services provided by the requesting system;
obtaining social network information for the individual from a social network service in which the individual is a member; and
providing the social network information to the requesting system in response to the received request.

2. The method of claim 1, further comprising:
determining a verification score to assign to the individual based on the obtained social network information; and
wherein providing the social network information to the requesting system includes providing the verification score to the requesting system.

3. The method of claim 1, further comprising:
verifying the individual based on the obtained social network information; and
wherein providing the social network information to the requesting system includes providing an indication of the verification of the individual to the requesting system.

4. The method of claim 1, wherein obtaining social network information for the individual from a social network service in which the individual is a member includes obtaining professional information from a professional social network in which the individual is a member.

5. The method of claim 1, further comprising:
parsing the request to identify specific information requested by the requesting system; and
wherein obtaining social network information for the individual from a social network service in which the individual is a member includes obtaining the specific information from the social network service.

6. The method of claim 1, wherein providing the social network information to the requesting system in response to the received request includes transmitting the social network information directly to the requesting system.

7. The method of claim 1, wherein providing the social network information to the requesting system in response to the received request includes transmitting the social network information a device associated with the individual.

8. The method of claim 1, wherein providing the social network information to the requesting system in response to the received request includes performing an action via an application associated with the social network service that is supported by a computing device associated with the individual.

9. A system, comprising:
a request module, wherein the request module is configured to receive a request from a requesting system to provide information associated with an individual seeking access to services provided by the requesting system;
an information module, wherein the information module is configured to obtain social network information for the individual from a social network service in which the individual is a member; and
a verification module, wherein the verification module is configured to provide the social network information to the requesting system in response to the received request.

10. The system of claim 9, wherein the information module is configured to determine a verification score for the individual based on the obtained social network information; and
wherein the verification module is configured to provide the determined verification score to the requesting system.

11. The system of claim 9, wherein the information module is configured to obtain professional information associated with the individual; and
wherein the verification module is configured to provide the professional information to the requesting system.

12. A computer-readable storage medium whose contents, when executed by a computing system, cause the computing system to perform operations for verifying an individual requesting access to an online web service, comprising:
at a social network service that includes the individual as a member, receiving a request from the online web service to verify the individual; and
transmitting to the online web service information associated with a verification determination for the individual.

13. The computer-readable storage medium of claim 12, wherein the transmitted information includes information associated with work experience attributed to the individual.

14. The computer-readable storage medium of claim 12, wherein the transmitted information includes information associated with educational activities attributed to the individual.

15. The computer-readable storage medium of claim 12, wherein the transmitted information includes information associated with a number of connections within the social network for the individual.

16. The computer-readable storage medium of claim 12, wherein the transmitted information includes information associated with attributes assigned to other members of the social network connected to the individual within the social network.

17. The computer-readable storage medium of claim 12, wherein the transmitted information includes information associated with a verification score determined for the individual.

18. The computer-readable storage medium of claim 12, wherein the transmitted information includes information associated with a positive or negative verification determination for the individual.

19. The computer-readable storage medium of claim 12, wherein the transmitted information includes information associated with a challenge question to be posed to the individual via the online web service.
